(19) United States
(12) Patent Application Publication
(10) Pub. No.: US 2016/0119699 A1
(43) Pub. Date: Apr. 28, 2016

(54) UMBRELLA MOUNTED SOUND SYSTEM

(71) Applicant: Rachel CABAN, Staten Island, NY (US)

(72) Inventor: Rachel CABAN, Staten Island, NY (US)

(21) Appl. No.: 14/520,687

(22) Filed: Oct. 22, 2014

(51) Int. Cl. H04R 1/02; A45B 25/00

(52) U.S. Cl. CPC H04R 1/025; A45B 25/00; H04R 1/023; A45B 2025/003; A45B 2200/1009; H04R 2201/028; H04R 2420/07

(57) ABSTRACT

A sound system for mounting to an umbrella includes a housing and at least one speaker. The system further includes an amplifier, at least one input device, and a power source. The system further includes an upper coupler that engages a male coupling element on an upper shaft of the umbrella. The system further includes a lower coupler that engages a female coupling element on a lower shaft of the umbrella.

### TECHNICAL FIELD

The apparatus described herein relates to the audio field, more particularly, to the field of portable audio systems.

### BACKGROUND

Ever since the introduction of the cassette tape in the 1970s, consumers have used various portable music solutions. The cassette tape enabled this technology because they were a highly portable medium. In the 1970s and 1980s, people would carry large boomboxes with cassette tapedecks to listen to music when they were away from their stereo system or vehicle. This became so commonplace that the sight of adolescents blasting boomboxes in public places became a stereotype in the 1980s.

Eventually cassette technology was miniaturized and by the mid 1980s portable cassette players such as the Walkman™ became commonplace. These were a significant improvement in terms of size and weight over the boombox. They also allowed people to listen to their music with headphones and not create a nuisance.

Eventually the CD was developed and portable CD players and CD based boomboxes took over the market during the 1990s. CDs were eventually supplanted by hard drive and solid-state drive based mp3 players in the 2000s. However, the sound generating systems (namely headphones or large portable speakers) remained the same. Neither system is particularly well-suited for outdoor gatherings (such as at beaches), where users frequently need a portable sound system. Boomboxes are too bulky and susceptible to damage from sand and the elements. Moreover, many boomboxes use antiquated technology and require some creative (and inconvenient) solutions to interface with modern mp3 players and smartphones. Headphones block off other sounds from the wearer and may impede conversation. Moreover, a headset is needed for each individual at the gathering who wishes to listen to music.

There is a need in the art for a portable sound system tailored for outdoor use.

### BRIEF SUMMARY

A sound system for mounting to an umbrella includes a housing and at least one speaker. The system further includes an amplifier, at least one input device, and a power source. The system further includes an upper coupler that engages a male coupling element on an upper shaft of the umbrella. The system further includes a lower coupler that engages a female coupling element on a lower shaft of the umbrella.

In some embodiments, the at least one input device includes a headphone jack. In some embodiments, the at least one input device includes a wireless communicator. In some embodiments, the wireless communicator is a bluetooth transceiver. In some embodiments, the wireless communicator is a wifi transceiver. In some embodiments, the amplifier and wireless communicator are on integrated circuit boards. In some embodiments, the power source is a battery array. In some embodiments, the system further includes a speaker mounting board coupled to the at least one speaker. In some embodiments, the housing has a cylindrical shape. In some embodiments, the housing is composed of two halves mated to each other. In some embodiments, the system further includes at least one cutout in the housing that allows sound to travel from the at least one speaker to an exterior of the housing, and at least one screen covering the at least one cutout.

A method of assembling an umbrella with a sound system includes providing an umbrella having a disassembled upper shaft and lower shaft. The method further includes providing a sound system having an upper coupler and a lower coupler. The method further includes inserting the lower coupler into a female coupling element on the lower shaft. The method further includes securing the lower coupler in the female coupling element. The method further includes inserting a male coupling element on the upper shaft into the upper coupler. The method further includes securing the male coupling element in the upper coupler.

In some embodiments, securing the lower coupler in the female coupling element includes tightening a clamp. In some embodiments, securing the male coupling element in the upper coupler includes tightening a clamp. In some embodiments, the method further includes connecting a portable mp3 player to the sound system subsequent to securing the upper shaft in the upper coupler. In some embodiments, the connection between the mp3 player and sound system is achieved using a microphone cable and microphone jacks in the sound system and mp3 player. In some embodiments, the connection between said mp3 player and sound system is achieved using a wireless communicators in the sound system and the mp3 player. In some embodiments, the method further includes staking the lower shaft of the umbrella into the ground prior to inserting the lower coupler in the female coupling element.

### BRIEF DESCRIPTION OF THE DRAWINGS

FIG. 1 is a perspective view of the apparatus attached to a beach umbrella.

FIG. 2 is a close-up perspective view of the embodiment shown in FIG. 1.

FIG. 3 is a rear perspective view of the embodiment shown in FIG. 1.

FIG. 4 is an exploded perspective view of the embodiment shown in FIG. 1.

FIG. 5 is schematic of the electrical components of the embodiment shown in FIG. 1.

### DETAILED DESCRIPTION

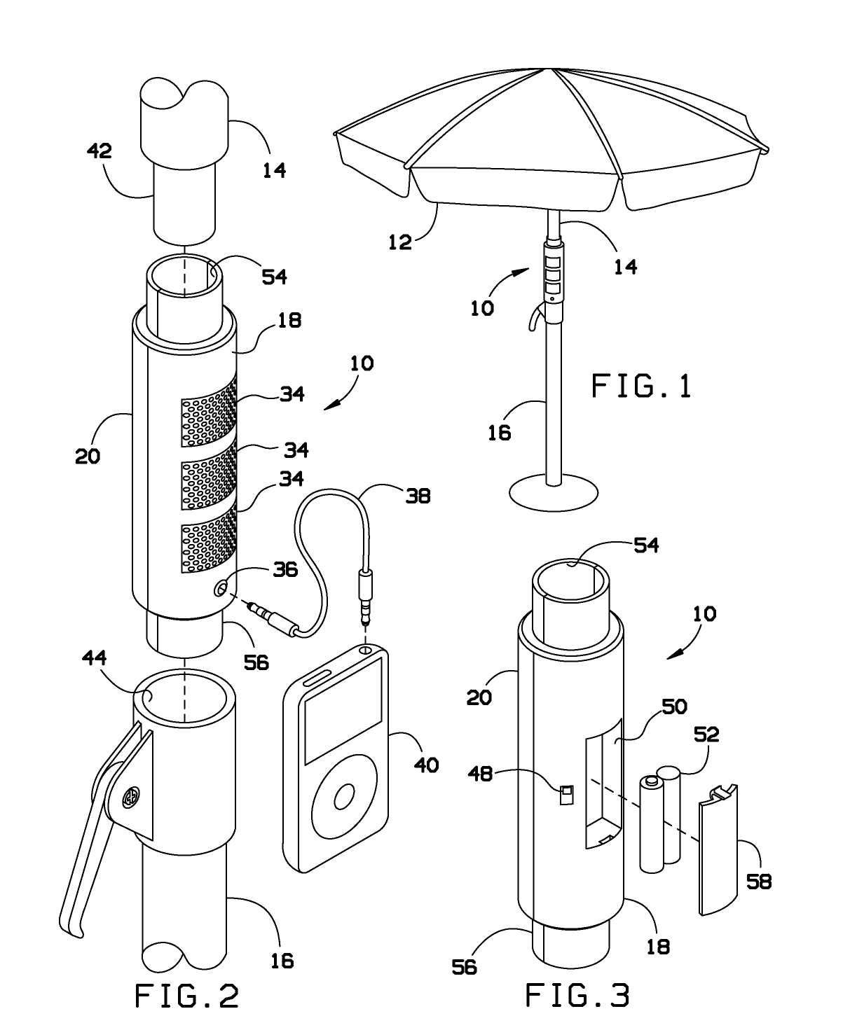

FIG. 1 is a perspective view of the apparatus 10 attached to a beach umbrella which includes a canopy 12, upper shaft 14, and lower shaft 16. Apparatus 10 couples to upper shaft 14 and lower shaft 16 through the coupling system that would normally couple upper shaft 14 to lower shaft 16. Beach umbrellas are typically capable of breaking into two pieces as shown because lower shaft 16 may need to be hammered into the ground or sand before upper shaft 14 and canopy 12 are attached. It should be appreciated that in other embodiments, apparatus 10 may be attached to any type of umbrella that can be broken into multiple pieces as shown in FIG. 1.

FIG. 2 is a close-up perspective view of apparatus 10. As can be seen, apparatus 10 couples to lower shaft 16 with lower coupler 56 and couples to upper shaft 14 with upper coupler 54. In this embodiment, upper shaft 14 has a tapered end 42. Tapered end 42 acts as a male element and enters upper coupler 54 on apparatus 10 to engage it. In this embodiment, lower shaft 16 has a flared end 44 that acts as a female element and surrounds and engages lower coupler 56 on apparatus 10. In some embodiments, upper coupler 54 is a female coupling element with a clamp to emulate the flared end 44 of lower shaft 16. Upper coupler 54 and lower coupler 56 form sturdy connections to upper shaft 14 and lower shaft 16 to prevent the wind from breaking the umbrella.

In this embodiment, apparatus 10 has a front housing 18 that covers the front of the device and a rear housing 20 that covers the rear of the device. Front housing 18 and rear housing 20 can be constructed from aluminum, plastic, or other materials. Front housing 18 has cutouts for speaker grills 34. In this embodiment, there are three speaker screens 24. Front housing 18 also has a perforation for a ⅛th inch speaker jack 36 in this embodiment. In this embodiment, apparatus 10 is connected via speaker jack 36 to a portable mp3 player via ⅛th inch speaker cable 38.

FIG. 3 shows the rear housing 20 of apparatus 10. In this embodiment, rear housing 20 comprises an on/off switch 48 and a battery compartment 50. Battery compartment 50 encases battery array 52 that powers apparatus 10. In this embodiment, battery array 52 is two AAA batteries. Battery compartment 50 engages cover 58 to enclose and secure battery array 52.

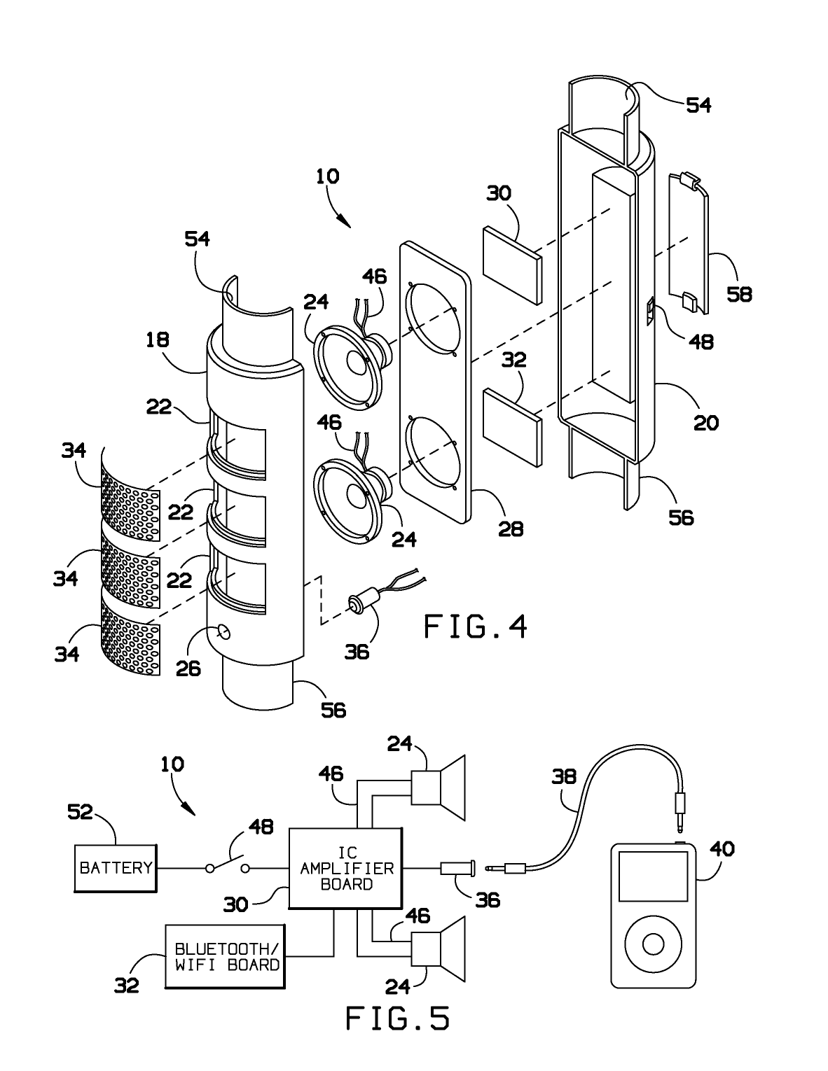

FIG. 4 is an exploded view of apparatus 10 that shows the internals of apparatus 10. In this embodiment, apparatus 10 includes two speakers 24 that are connected to the electrical system by speaker wires 46. Speakers 24 are mounted to a speaker mounting board 28 in this embodiment. In this embodiment, speakers 24 are rust-resistant 40 mm round speakers rated at 4 ohms and 6 watts max. Speakers 24 are rust-resistant in this embodiment to withstand outdoor and shoreline conditions. In some embodiments, speakers 24 are ovular or other shapes.

In this embodiment, apparatus 10 includes an amplifier board 30 and a wireless communication board 32. Amplifier board 30 drives speakers 24 to generate audio. In this embodiment, amplifier board 30 is rated at 6 watts max, and is one square inch to save space. Wireless communication board 32 includes wifi and bluetooth transceivers in this embodiment. Wireless communication board 32 allows wireless audio players to remotely play sounds through apparatus 10. Wireless communication board 32 also allows regional broadcasts to be picked up by all of the apparatus' 10 in the area. This could be used, for example, to send an emergency broadcast, weather report, or advertisements to all of the visitors on a beach. In this embodiment, wireless communication board 32 is one square inch. Wireless communication board 32, amplifier board 30, and speakers 24 are compact yet powerful in order to fit compactly on the umbrella shafts 14, 16 while being loud enough for outdoor use.

FIG. 5 is schematic of the electrical components of the embodiment shown in FIG. 1. Battery array 52 powers the circuitry in apparatus 10. On/Off switch 48 connects or disconnects battery array 52 and power from amplifier board 30. In this embodiment, amplifier board 30 is an integrated circuit. Wireless communication board 32 (bluetooth/wifi in this embodiment) and headphone jack 36 provide audio input to amplifier board 30, which amplifies signals from those devices and sends the amplified signal to speakers 24 via speaker wires 46.

The apparatus 10 described herein accomplishes the goals of integrating a sound system into an outdoor umbrella. This is convenient for music fans, revelers, and patrons because it is highly portable, elegant, and places the sound system in an ideal location. Outdoor umbrellas and beach umbrellas are already ubiquitous in outdoor meeting places—therefore, an ability to integrate sound systems into this existing infrastructure is advantageous. This system is also advantageous for outdoor venues such as beaches, parks, and restaurants who can use it as a broadcasting system.

Although the invention has been described with reference to embodiments herein, those embodiments do not limit the invention. Modifications to those embodiments or other embodiments may fall within the scope of the invention.

What is claimed is:

1. A sound system for mounting to an umbrella, comprising:
a housing;
at least one speaker;
an amplifier;
at least one input device;
a power source;
an upper coupler that engages a male coupling element on an upper shaft of the umbrella; and
a lower coupler that engages a female coupling element on a lower shaft of the umbrella.

2. The system of claim 1, wherein said at least one input device includes a headphone jack.

3. The system of claim 1, wherein said at least one input device includes a wireless communicator.

4. The system of claim 3, wherein the wireless communicator is a bluetooth transceiver.

5. The system of claim 3, wherein the wireless communicator is a wifi transceiver.

7. The system of claim 3, wherein said amplifier and wireless communicator are on integrated circuit boards.

8. The system of claim 1, wherein said power source is a battery array.

9. The system of claim 1, further comprising:
a speaker mounting board coupled to said at least one speaker.

10. The system of claim 1, wherein said housing has a cylindrical shape.

11. The system of claim 1, wherein said housing is composed of two halves mated to each other.

12. The system of claim 1, further comprising:
at least one cutout in said housing that allows sound to travel from said at least one speaker to an exterior of said housing; and
at least one screen covering said at least one cutout.

13. A method of assembling an umbrella with a sound system, comprising:
(a) providing an umbrella having a disassembled upper shaft and lower shaft;
(b) providing a sound system having an upper coupler and a lower coupler;
(c) inserting the lower coupler into a female coupling element on the lower shaft;
(d) securing the lower coupler in the lower shaft;
(e) inserting a male coupling element on the upper shaft into the upper coupler; and
(f) securing the upper shaft in the upper coupler.

14. The method of claim 13, wherein step (d) includes tightening a clamp.

15. The method of claim 13, wherein step (f) includes tightening a clamp.

16. The method of claim 13, further comprising:
(g) connecting a portable mp3 player to the sound system subsequent to step (f).

17. The method of claim 16, wherein the connection in step (g) is achieved using a microphone cable and microphone jacks in the sound system and mp3 player.

18. The method of claim 16, wherein the connection in step (g) is achieved using a wireless communicators in the sound system and the mp3 player.

19. The method of claim 13, further comprising:
(g) staking the lower shaft of the umbrella into the ground prior to step (c).
